(19) United States
(12) Patent Application Publication
(10) Pub. No.: US 2005/0011652 A1
(43) Pub. Date: Jan. 20, 2005

(54) Spray head and nozzle arrangement for fire suppression

(76) Inventor: Jinsong Hua, Singapore (SG)

Correspondence Address: BIRCH STEWART KOLASCH & BIRCH, PO BOX 747, FALLS CHURCH, VA, 22040-0747, US

(21) Appl. No.: 10/620,606

(22) Filed: Jul. 17, 2003

(51) Int. Cl. A62C 35/00

(52) U.S. Cl. 169/37; 239/543; 239/544; 239/596; 169/16

(57) ABSTRACT

A water spray head for spraying water spray mist in a fire prevention system, includes a water supply duct; a spray head upper body; a fluid chamber; and a “w” shaped bottom, on which at least two rings of nozzles are installed. The water spray head has a body with a “w” shaped bottom, a chamber and two rings of liquid mist nozzles on the slant walls of the “w” shaped bottom. The liquid mist sprays from the nozzles at the inner ring may collide with each other directly or tangentially to form finer liquid droplets and a more uniformly distributed “solid cone” water spray. The water mist formation of the individual nozzle is also designed to be based on the collision of liquid streams from multiple small flow channels in a large flow channel, thereby forming even finer droplets.

### FIELD OF THE INVENTION

The present invention is directed to a novel design of water spray head and nozzle and, more particularly, to an installation and arrangement of a water spray head and nozzle which may be used to produce a “solid cone” liquid mist spray for fire suppression. The new designed spray head and nozzle is efficient in fire suppression while having low costs of fabrication, installation and maintenance, and also having a high adaptability to various fire service requirements.

### BACKGROUND OF THE INVENTION

Water sprinkler systems are widely used for fire suppression and prevention. However, traditional water sprinklers have a number of drawbacks. One of these drawbacks is that they typically require an undesirably high amount of water to suppress a fire, thereby often causing severe damage due to over-flooding or wetting.

In recent years, water mist sprays, which have much finer liquid droplets than that of sprinkler sprays, are becoming increasingly popular for use in fire suppression because of several reasons. Water mist with finer droplets can extinguish a fire more effectively, and with less water usage. This may reduce not only the direct cost of suppressing a fire, but also the indirect damage caused by water wetting when excessive water is used, such as in a sprinkler system. Water used as a fire suppressing agent is friendly to the environment. Hence, it is considered as a potential replacement of the “Hallon” fire extinguishing system, which is harmful to ozone layer of the atmosphere. Moreover, water is a kind of low cost fire-extinguishing agent of which there is a practically sufficient supply in nature.

The mechanisms by which water mist sprays act to extinguish, suppress, or control a fire can be a combination of several factors. As a result of heat extracted from a fire as water evaporates, both fuel and fire plumes may be cooled and lower the rate of the chemical reaction in a fire combustion. Oxygen levels are reduced as water displaces oxygen near the fire. The wetting and cooling of the combustibles occurs directly as the water mist impinges on the combustibles. The protected area and adjacent combustibles are enveloped in cool gases, as well as pre-wetted and blocked from the transfer of radiation heat. The flammable vapours are diluted by entrainment of water droplets to such an extent that the resultant mixture of vapour does not burn.

Hence, fine water mist is a good candidate for a fire extinguishing agent. From the point of view of an engineering application, challenges of using fine water mist for fire protection and suppression are present in the design of efficient spray heads and mist nozzles, which can produce a preferable spray pattern and droplet size with low costs of fabrication, installation, operation and maintenance. Generally speaking, the droplet size of the spray mist is determined by the kind of spray nozzle, and the spray pattern of a spray head is determined by the arrangement of the nozzles installed.

Various approaches in producing water mist through spray nozzles are disclosed in U.S. Pat. Nos. 5,839,667 and 5,505,383 and WO 02/00302 A2, each of which are incorporated herein by reference. Generally, the methods of water mist formation can generally be classified as direct or diffuser impingement, pressure jet, gas-atomising, and jet interaction.

Diffuser impingement nozzles operate by impacting a medium velocity, relatively coherent water jet against a diffuser. The diffuser breaks the stream into a high momentum mist with the widest range of droplet sizes compared to other types water mist nozzles. Typically, 90% of the droplets are smaller than 600 microns. Impingement nozzles presently on the market operate over a range of pressure from about 7 bar (100 psi) to 17 bar (250 psi). A pendent-type diffuser impingement water mist nozzle is disclosed in U.S. Pat. No. 5,839,667. A water mist nozzle of a spherical diffuser impingement type is disclosed in U.S. Pat. No. 5,505,383. Finally, WO 02/00302 A2 discloses a design of an upright-type fire protection water spray mist nozzle.

Pressure jet water mist nozzles function by discharging high velocity streams of water through a number of very small orifices. These systems typically employ a swirling action device within the chambers or nozzles to help break up the water streams. The pressure jet nozzles operate over a pressure range from about 5 bar (70 psi) to 280 bar (400 psi). Typically, 90% of the droplets of a pressure jet nozzle are smaller than 150 microns, at least for those operating at the high end of the pressure range. Typical designs of this type of nozzle are reported in the patents U.S. Pat. Nos. 6,129,154 and 4,570,860, and WO 97/43046, each of which are incorporated herein by reference.

Gas-atomising water mist nozzles, also known as twin-fluid nozzles, generate water mist by combining compressed gas with water in a mixing chamber located just upstream of the discharging orifices. The gas-atomising nozzles use a water pressure of about 5 bar (75 psi). The compressed gas mixes with water such that 90% of droplets are smaller than 250 microns. Examples of gas-atomising mist nozzles can be found in U.S. Pat. Nos. 5,597,044 and U.S. Pat. No. 6,390,203 B1, each of which are incorporated herein by reference.

Jet interaction water mist nozzles use multiple pairs of fine fluid jets colliding with each other at certain angles to break up the fluid stream and form water droplets. Jet interaction nozzles typically operate over a pressure range from about 3 bar (45 psi) to 7 bar (100 psi). Currently, applications of jet interaction nozzles are limited to manual hose nozzle for extinguishing low volatility flammable liquid fires by cooling and dilution. Generally, jet interaction nozzles can generate quite fine droplets with relatively low momentum. Jet interaction nozzles are illustrated, for example, in U.S. Pat. No. 6,155,501 and WO 95/18651, each of which are incorporated herein by reference.

The droplet size is one of the key actors that affect the efficiency of water mist sprays in fire extinction. Finer water droplets have a much greater surface area than coarser droplets at the same spray flux. This greater droplet surface area can significantly increase the heat transfer rate, and hence quicken heat extraction from the fire and the water evaporation rate. As a result, fire extinction by sprays that produce fine water droplets is relatively faster than those that produce coarse droplets. However, to generate water mist with fine water droplets, the discharging orifice size of the water mist nozzle is normally quite small. Hence, the water flux delivered through a single nozzle is also quite small.

As disclosed in the article “A Numerical Study of the Interaction of Water Spray with A Fire Plume” on Fire Safety Journal Vol. 37 (2002), pp. 631-657, which is incorporated herein by reference, a minimum water mist spray flux is required to successfully extinguish a fire. Consequently, it is quite difficult to suppress a practical fire efficiently just using a single water mist nozzle. Hence, the water spray head with multiple mist nozzles installed is suggested and designed for the fire protection purpose. It is also disclosed in the article that the “solid cone” water mist spray is more effective in fire suppression because the water droplets can be directly delivered to the fire combustion zone. Even though the spray pattern of an individual nozzle may be a “solid cone” or a “hollow cone”, the general spray pattern of spray heads currently available on the market, including spray heads with multiple water mist nozzles, mostly belongs to the “hollow cone” type due to the diverging arrangement of the water mist nozzles on a spray head. Examples of such “hollow cone” spray heads are disclosed in WO 01/45799 A1 and WO 97/43046, each of which is incorporated herein by reference. In addition, the number of “solid cone” spray heads required to suppress a fire under the cover area may be less than that of the “hollow cone” spray head. This is because the “hollow cone” spray head cannot deliver water droplets directly to the fire source under the spray head and suppress the fire immediately. The further fire growth may activate more neighbouring spray heads. The activation of more neighbouring spray heads helps in fire suppression. However, if more spray heads are activated, the pressure drop in the main water supply pipe will drop significantly, and the performance of each spray head will also be affected. In addition, more spray heads activated may lead to a larger wetting area caused by the water sprays, which may cause larger wetting damage due to excessive water usage.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### SUMMARY OF THE INVENTION

Accordingly, the present invention is directed to a spray head and nozzle arrangement for fire suppression that substantially obviates one or more problems due to the limitations and disadvantages of the related art.

An object of the present invention is to provide a novel design of water mist nozzle and spray head for fire suppression in which the droplet size of water mist produced by the nozzle is fine enough so that the same amount of water with finer droplets has a much larger total droplet surface area than that with coarse droplets. This significantly enhances the heat transfer rate between the water mist spray and fire plume, which enhances its effectiveness in fire suppression.

Another object of the present invention is to provide a spray flux of a spray head that is higher than a threshold value so that a fire of a certain size and heat release rate can be successfully extinguished. Otherwise, the fire cannot be suppressed no matter how long the water spray operates. On the other hand, the water mist spray flux should not be so high as to waste water and cause high wetting damage.

Yet another object of the present invention is to provide a plurality of water mist nozzles that are installed and properly arranged on a spray head to increase total water mist flux with a suitable spray pattern. A plurality of water mist nozzles is preferable because the water flux of a single water mist nozzle is not high enough. The spray head should have a high flexibility to adapt to various fire sizes, scenarios and services. The manufacturing, installation and maintenance of the spray head and nozzles should be as simple as possible while retaining the same performance in mist generation.

Since the gas-atomising system needs two piping systems to supply liquid and gas, it makes the whole system more complex, and operations more costly. For the pressure jet nozzle, normally some swirling devices are designed in the nozzle to break up the streams. However, the rotating parts in the fine nozzle are not only expensive to fabricate but also may be clogged due to dust or debris in operation when improperly maintained. Hence, in this invention, the mist formation of the nozzle combines the mechanisms of jet impingement on a wall, jet interaction, pressured jet through small orifice without any rotating component, the details of which are illustrated hereinafter. Based on this design, water mist droplets produced by the new nozzle will have a quite wide distribution range of droplet size. The distribution of the droplet size and mist momentum can also be adjusted by changing the flow channel, orifice size and directions of jet. Hence, the contributions of the mist formation mechanisms of pressure jet, wall impingement and jet interaction can be varied according to the requirement. The operating pressure of the nozzle will be in a medium range, which saves the operation cost. The fabrication of this nozzle is also quite easy, since no moving parts are involved. The operation is also more stable and the maintenance of nozzle is easy.

Yet another object of the present invention is to provide a design of spray head on which multiple nozzles are installed. As is known, the water mist spray pattern of most current market available spray heads is of a “hollow cone” type, which is not effective in fire suppression. In this invention, a “w” shaped spray head bottom is adopted and two rings of the nozzles are installed on the slant surface. The outer ring nozzles are used to spray the mist outward and downward, which mostly works like the traditional spray head. The inner ring nozzles are used to spray mist inward and downward. The mist sprays from the inner ring nozzle strike each other, and the strong collision further breaks up the water droplets forming-finer water droplets, which is more helpful in fire extinguishing. As such, the new design of the spray head can generate a finer, “solid cone” water spray, which is more efficient for fire suppression.

Yet another object of the present invention is to provide nozzles and a spray head that are functionally separated and that can be easily assembled together by a thread. A series of nozzles and spray heads can be designed according to various fire scenarios and fire prevention requirement. The combinations of these nozzles and spray heads may form various products for different fire safety service purposes. For example, the fire service requirement changes with the changes of a building's function. For the water mist spray system with this invention, only the old nozzles need to be replaced easily with new nozzles to satisfy the requirement without changing the whole system. Accordingly, the present invention grants greater flexibility to the system and saves a lot in system maintenance cost.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a water spray head for spraying water spray mist in a fire prevention system, includes a water supply duct (1); a spray head upper body (2); a fluid chamber (3); and a “w” shaped bottom (4), on which at least two rings of nozzles (6, 8) are installed.

In another aspect of the present invention, a water mist nozzle of a water spray head for generating water mist, includes a cylindrical body (7); a channel (20) at a discharging end (22) along an axis of the water mist nozzle; and a plurality of channels at an inlet end (19) of the water mist nozzle, including a central small channel (24) and side slant channels (23), the channel (20) at the discharging end (22) being larger than the plurality of channels at the inlet end (19).

It is to be understood that both the foregoing general description and the following detailed description of the present invention are exemplary and explanatory and are intended to provide further explanation of the invention as claimed.

The present invention will become more fully understood from the detailed description given hereinbelow and the accompanying drawings, which are given by way of illustration only, and thus are not limitative of the present invention, and wherein:

### BRIEF DESCRIPTION OF THE DRAWINGS

The accompanying drawings, which are included to provide further understanding of the invention and are incorporated in and constitute part of this application, illustrate embodiments of the invention and together with the description serve to explain the principle of the invention. In the drawings:

FIG. 1a illustrates a schematic diagram of the fire suppression using water sprays of “hollow cone” pattern.

FIG. 1b illustrates a schematic diagram of the fire suppression using a water spray of “solid cone” pattern.

FIG. 2 illustrates an outline of the spray head and installations of water mist nozzles.

FIG. 3 illustrates a direct collision of water mist sprays from an inner ring of nozzles.

FIG. 4 illustrates a tangentially collision of water mist spray from an inner ring of nozzles, which is an alternative design to that shown in FIG. 3.

FIG. 5a illustrates a cross sectional side view of water mist spray nozzle.

FIG. 5b illustrates a top view of water mist spray nozzle shown in FIG. 5a.

FIG. 6a illustrates a cross sectional side view of water mist spray nozzle, an alternative design to that shown in FIG. 5a.

FIG. 6b illustrates a top view of water mist spray nozzle that is shown in FIG. 6a.

### DETAILED DESCRIPTION OF THE PREFERRED EMBODIMENTS

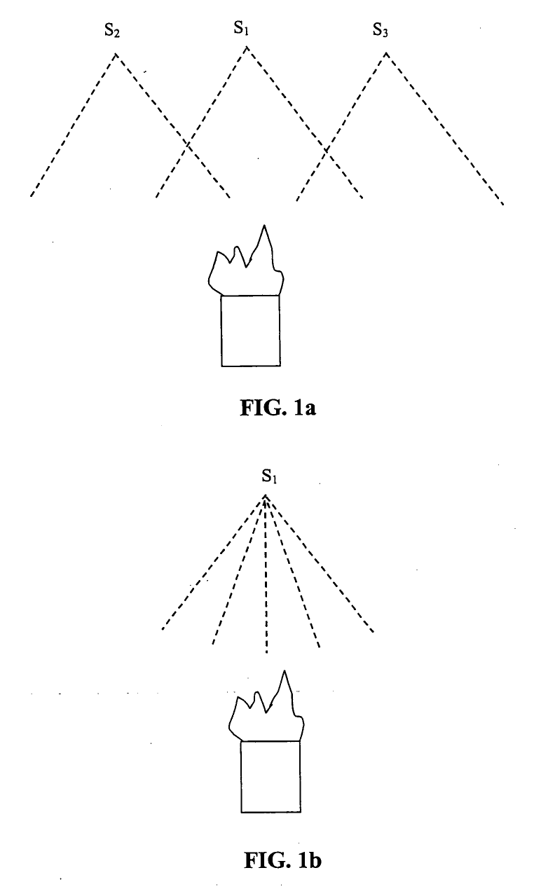

FIG. 1a illustrates a mechanism of extinguishing a fire by a “hollow cone” water mist spray. When an accident fire happens under spray head S₁, hot fire plume activates the spray head S₁. However, the “hollow cone” mist spray does not deliver the water droplets directly to the fire source, and does not suppress the fire quickly. The further growth of the fire plume may activate the neighbouring spray heads, such as S₂ and S₃. The neighbouring spray heads may deliver the water to fire source and suppress the fire. However, the activation of more spray heads may cause a pressure drop in the water supply pipe and affect the performance of each spray head. In addition, the more spray head is activated, the more water is required and used. The water flooding and wetting damage caused by excess water is higher. On the other hand, the “solid cone” mist spray can directly deliver water droplets to the fire source, the fire can be extinguished in its early growing stage as illustrated in FIG. 1b. No neighbouring spray head will be activated saving water usage and avoiding excess water flooding and extra wetting damage. Hence, “solid cone” water mist spray pattern is highly recommended for the effective fire extinguishing.

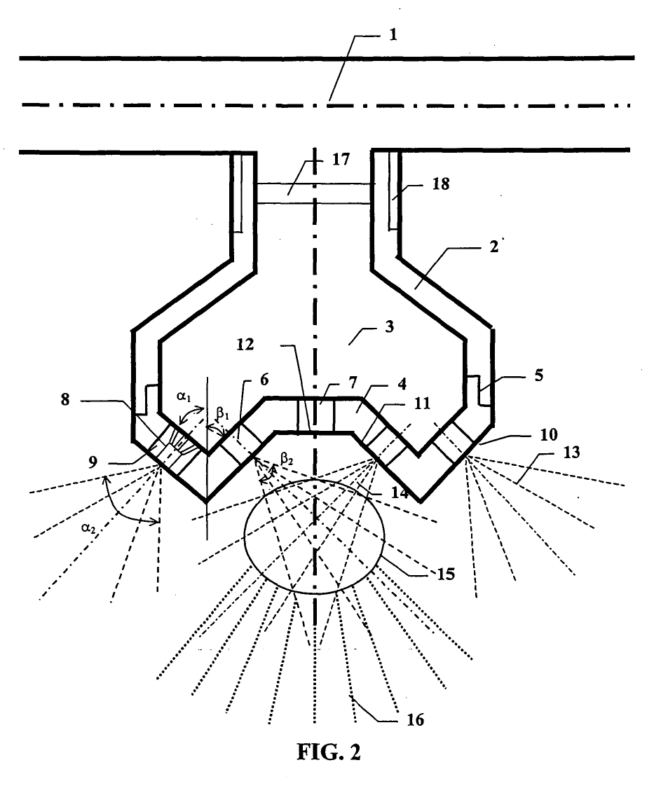

FIG. 2 illustrates an outline of a spray head and water mist installation in accordance with the present invention. The spray head comprises a spray head body 3, a “w” shaped bottom 4, and multiple water mist nozzles 6, 7 and 8. The spray head body 3 can be connected to a main water supply pipe 1, which supplies the necessary water flow rate at a proper pressure. A valve 17 is also provided between the main supply pipe 1 and the spray head 3 so that each spray head can be activated individually through the fire detection and alarm system. Inside the spray head 3, a chamber provides the flow path for water to flow to the multiple nozzles 6, 7 and 8 installed on the spray head bottom 4. The spray head bottom 4 has a cross section of “w” shape. At the bottom part of the spray head 3, there are two slant surfaces 10 and 11, on which two rings of nozzles 6 and 8 are installed. The nozzles are installed on the spray head body through the screw connections 9.

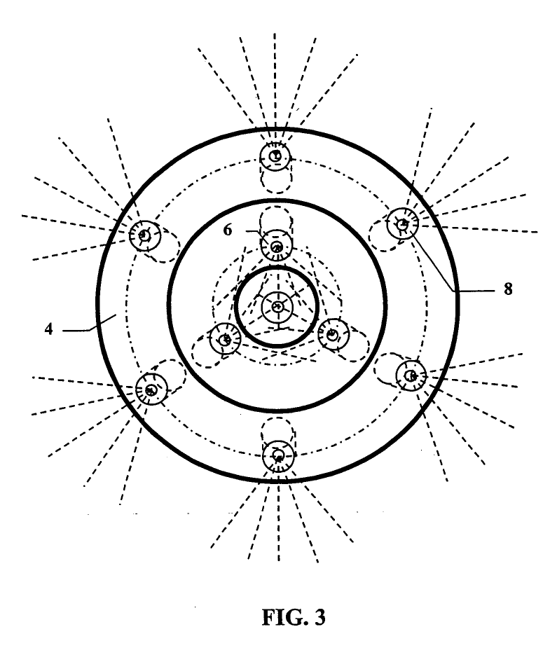

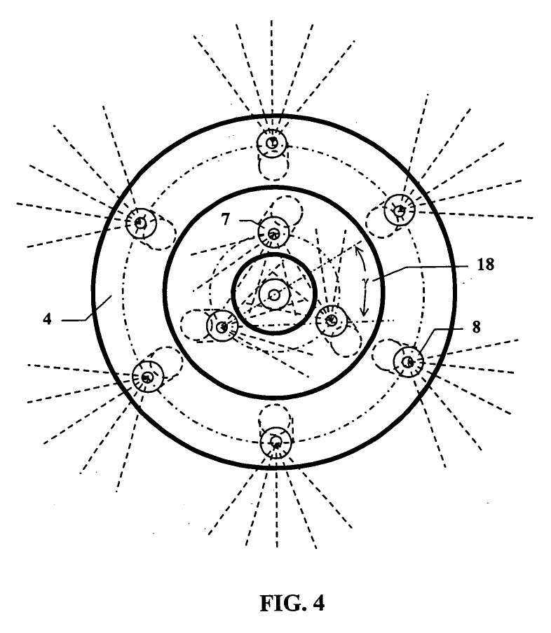

Normally, the mist spray cone axis of the nozzles 6 and 8 is normal to the slant surfaces 10 and 11. The slant angles α₁ and β₁ of the inner slant surface 11 and outer surface 10, respectively, decide the flow direction of water mist sprays 13 and 14 from the two rings of nozzles 6 and 8. The slant angle of the outer slant surface α₁ decides the cover area of the water mist spray. The slant angle of the inner slant surface β₁ decides the interaction/collision angle of the water sprays 14. Normally, the inner nozzle may be installed normal to the slant surface so that water spray from the inner nozzle can collide directly under the spray head at 15 as shown in FIG. 3. The liquid droplets may further break up forming a finer mist and a “solid cone” spray pattern 16. However, the direct collision of the water spray may cause the large loss of momentum of water mist spray 14. To avoid this situation, the inner nozzles may be tilted with an angle γ at 18 to the normal direction of the slant surface as shown in FIG. 4. And the mist spray from three or more inner nozzles may collide tangentially forming a swirling mist core under the spray head, which will result in a more reliable “solid cone” spray pattern.

The “w”-shaped bottom part 4 of the spray head is assembled with the upper body 2 of the spray head through screw thread connection. Hence, the bottom part 4 can be easily dismantled from the spray head for the purpose of maintenance, replacing the water mist nozzles with the new ones. On the centre flat face 12 of the bottom part 4 of the spray head, a downward water mist nozzle 7 can also be installed to generate a downward water mist spray, increasing the downward momentum and the penetration capability of the fine water mist.

Most fine water mist spray nozzles are composed of small orifices or flow channels. The liquid flow flux through each nozzle is so small that it is very hard to suppress a real sized fire using a single water mist nozzle. Hence, a spray head is designed to host multiple nozzles 6, 7 and 8 to increase the total water flux through the spray head. The positioning of the nozzles on a spray head will form a new global spray pattern that is different from that of each individual nozzle. In the present invention, the “w”-shaped spray head bottom 4 is proposed to form a “solid cone” water mist spray pattern. However, the spray pattern of each individual nozzle may be a “solid cone” or a “hollow cone.” The configurations of multiple nozzles including an orifice size, spray pattern and flow rate are not necessarily the same for one spray head. However, these nozzles should have a standard installation configuration to the body of spray head. Hence, the various nozzles selected based on the requirement of fire service can be installed on one spray head. For example, the nozzles on the outer ring 8 may generate coarse droplets with higher momentum so that they can penetrate further and reach a larger covering area. On the other hand, the nozzles 6 on the inner ring produce finer droplet with high speed, and fine water mist cloud 16 can be formed after the droplet collision at 15. And high momentum nozzle 7 will push the water mist cloud downward to effectively extinguish the fire. The opportunity of combining various water mist nozzles within one spray head will offer a great possibility to optimise the spray head performance according to the particle fire protection requirement.

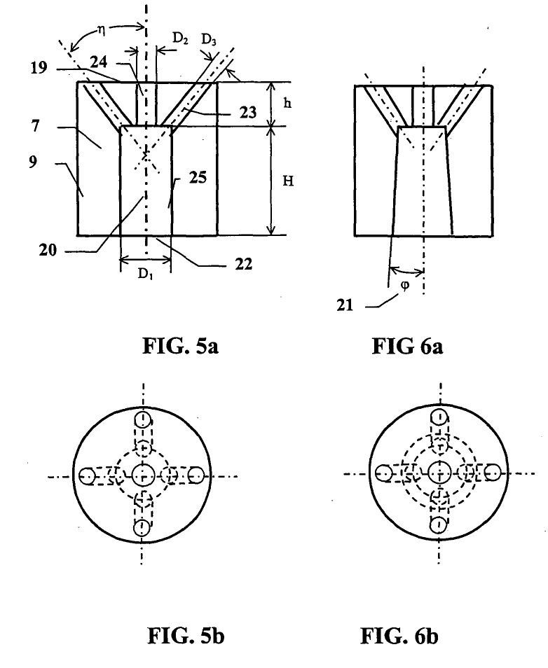

FIG. 5a illustrates a cross sectional side view of the new design of a water mist nozzle, and FIG. 5b illustrates a top view of the water mist nozzle shown in FIG. 5a. The body of each of the water mist nozzles 6, 7 and 8 is actually a cylinder with outer screw thread 9, which can be easily connected to the spray head at the bottom 4 through a screw thread. The water nozzle has a larger outlet channel 20 at the discharging end 22 to delivery the water mist, and several smaller channels at the inlet end 19. The small channels 23 and 24 are connected with the body chamber of the spray head. At the inlet end, there is a small central channel 24 alight with the cylinder axis, and several slant side small flow channels 23. All these small channels will converge in the large exhaust channel 20. So the flow streams from the small channels 23 and 24 will collide with each other in the large channel 20. These flow streams may also collide on the wall 25 of outlet channel and further break up the water droplet. The large channel 20 is characterized by a diameter D₁, a depth H and an open angle φ. To achieve a larger cover area of each nozzle, the open angle of the large channel 20 may be an open angle φ slightly larger than zero as shown in FIG. 6a and FIG. 6b. The central small channel can be characterized by a diameter D₂ and a depth h and the side slant small channels can be characterized by a diameter D₃, slant angle η as well as depth h.

In the spray head design, the numbers of inner nozzles 6 and outer nozzles 8 installed on the spray head bottom 4 are not necessarily to be the same as those shown in FIG. 3 and FIG. 4. In the nozzle design, the number of side slant small channels is not fixed to be four as shown in FIG. 5b and FIG. 6b. These configurations may vary according to the requirements of fire suppression. Also, it is impractical to give detail dimensions of the spray head and nozzles herein, the detailed dimensions should dependent upon the product design according to the requirement.

Numerous additional modifications and variations of the present invention are possible in light of the above teachings. It is therefore to be understood that within the scope of the appended claims, the invention may be practiced otherwise than as specifically described herein.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A water spray head for spraying water spray mist in a fire prevention system, comprising:
a water supply duct;
a spray head upper body; a fluid chamber; and
a “w” shaped bottom, on which at least two rings of nozzles are installed.

2. The water spray head as in claim 1, wherein the at least two rings of nozzles include an outer ring and an inner ring, the nozzles installed on the outer ring are pointed outward and downward and the nozzles installed on the inner ring are pointed inward and downward.

3. The water spray head as in claim 1, wherein the spray head produces finer water mist spray than each individual nozzle.

4. The water spray head as in claim 2, wherein water mist sprays from the inner ring of nozzles collide with each other to produce finer water droplets, thereby improving fire suppression efficiency.

5. The water spray head as in claim 4, wherein the nozzles on the inner ring are installed with a tilt angle (γ) so that the spray mist from the inner nozzle collides tangentially.

6. The water spray head as in claim 5, wherein a downward water mist nozzle is installed on a face of the spray head bottom.

7. The water spray head as in claim 1, wherein the water spray head has a solid cone spray pattern regardless of the spray pattern of each individual nozzle.

8. The water spray head as in claim 1, wherein the nozzles are assembled with the spray head by a thread screw connection.

9. The water spray head as in claim 8, wherein the nozzles can be easily replaced using new nozzles instead of a whole spray head when a potential fire scenario changes.

10. The water spray head as in claim 1, wherein some of the nozzles are installed with a stop, depending on the potential fire scenario.

11. A water mist nozzle of a water spray head for generating water mist, comprising:
a cylindrical body;
a main channel at a discharging end along an axis of the water mist nozzle; and
a plurality of channels at an inlet end of the water mist nozzle, including a central small channel and side slant channels, the channel at the discharging end being larger than the plurality of channels at the inlet end.

12. The water mist nozzle as in claim 11, wherein liquid flowing from channels at the inlet end converge into the channel at the discharging end.

13. The water mist nozzle as in claim 11, wherein the water mist is formed due to collisions of water jets from the small channels and the side slant channels at the inlet end colliding with each other at the main channel at the discharging end, droplet collisions on a channel wall and the effect of pressured jet through a small orifice.

14. The water mist nozzle as in claim 11, wherein a series of water nozzles with different performance and mist characteristics designed by varying one or more of a diameter, a depth, and a slant angle of the main channels, the small channels, and the side slant channels.

15. The water mist nozzle as in claim 11, wherein the nozzles are assembled with the spray head by a thread connection.

16. The water mist nozzle as in claim 19, wherein the nozzles can be easily replaced using new nozzles only instead of a whole spray head when a potential fire scenario changes.

17-18. (Canceled)
